(19) United States
(12) Patent Application Publication
(10) Pub. No.: US 2008/0259036 A1
(43) Pub. Date: Oct. 23, 2008

(54) Ergonomic keys

(76) Inventor: Jeffry Mixdorf, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/008,198

(22) Filed: Jan. 8, 2008

Related U.S. Application Data
(60) Provisional application No. 60/913,246, filed on Apr. 20, 2007.

(51) Int. Cl. G06F 3/02

(52) U.S. Cl. 345/168

(57) ABSTRACT

Key members of an article of manufacture can be detached and attached to keys of a keyboard of a computing device, such as a laptop or a cellular phone. These key members enhance visibility with the computing device. Colors, shapes, and types are used alone or in combination to enhance user interaction. Embellishments, such as embossment, may be used to further enhance tactile interaction.

### CROSS-REFERENCE(S) TO RELATED APPLICATION(S)

This application claims the benefit of U.S. Provisional Application No. 60/913,246, filed Apr. 20, 2007, which is incorporated herein by reference.

### BACKGROUND

Computing is becoming more personal, and correspondingly, its size (from supercomputers, to mainframes, superminicomputers, minicomputers, and work stations, to microcomputers, portable computers, and laptops, to personal digital assistants) is getting smaller, albeit with greater computing-abilities than before. However, the smaller size of computers affects the design and arrangement of input devices coupled to the computer, causing inefficient interaction between a user and a computer. Many of these input devices have distinct relations with one another which is not emphasized for the user, other than the characters presented on the input devices. In less than ideal interaction conditions, such as low light, it may be difficult for a user to use input devices which are constricted in a tight space. This may be exacerbated by many different visual conditions the user may have. Also, input devices, such as keyboards, are typically monochromatic, with small markings, making it difficult for the user to distinguish keys for interacting with the computer.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with an aspect of the present invention, an article of manufacture form of the present invention includes an article of manufacture for enhancing input device ergonomics, which comprises an adhesive layer, and a substrate layer fastened to the adhesive layer on which key member families of symbols, letters, and numbers are grouped according to colors, shapes, and types. Each key member is detachable from the article of manufacture and attachable to a corresponding key on a keyboard so as to allow better user interaction with a computing device.

In accordance with another aspect of the present invention, an apparatus form of the invention includes an input device to a computer, which comprises a keyboard with keys and key members of an article of manufacture which are organized into key member families of symbols, letters, and numbers according to colors, shapes, and types. Each key member is detachable from the article of manufacture and attachable to a corresponding key on the keyboard so as to allow better user interaction with the computer.

In accordance with a further aspect of the present invention, an apparatus form of the invention includes an input device to a cellular phone, which comprises an integrated keyboard with keys that are coupled to the cellular phone, and key members of an article of manufacture which are organized into key member families of symbols, letters, and numbers according to colors, shapes, and types. Each key member is detachable from the article of manufacture and attachable to a corresponding key on the keyboard so as to allow better user interaction with the cellular phone.

### DESCRIPTION OF THE DRAWINGS

The patent or application file contains at least one drawing executed in color. Copies of this patent or patent application publication with color drawing(s) will be provided by the Office upon request and payment of the necessary fee. The foregoing aspects and many of the attendant advantages of this invention will become more readily appreciated as the same become better understood by reference to the following detailed description, when taken in conjunction with the accompanying drawings, wherein:

FIG. 1 is a pictorial diagram of an exemplary laptop computer;

FIG. 2 is a pictorial diagram of an exemplary cellular phone;

FIG. 3 is a pictorial diagram of an exemplary article of manufacture;

FIG. 4 is a perspective diagram of a portion of the exemplary article; and

FIG. 5 is a perspective diagram of another portion of the article.

### DETAILED DESCRIPTION

Various embodiments of the present invention improve interactions between a user and a computer with small input devices, such as a keyboard, due to the computer's portability and size. Using colors allows the user to quickly and visually identify related keys while typing. Thus families of keys are created using colors, and not just black, white, and gray. Shapes can also be used to create families of keys, alone or in combination with colors. Type sizes, which are preferably larger than those used in conventional keyboards, and styles, such as capitalization or italicization, can be used to visually distinguish key members.

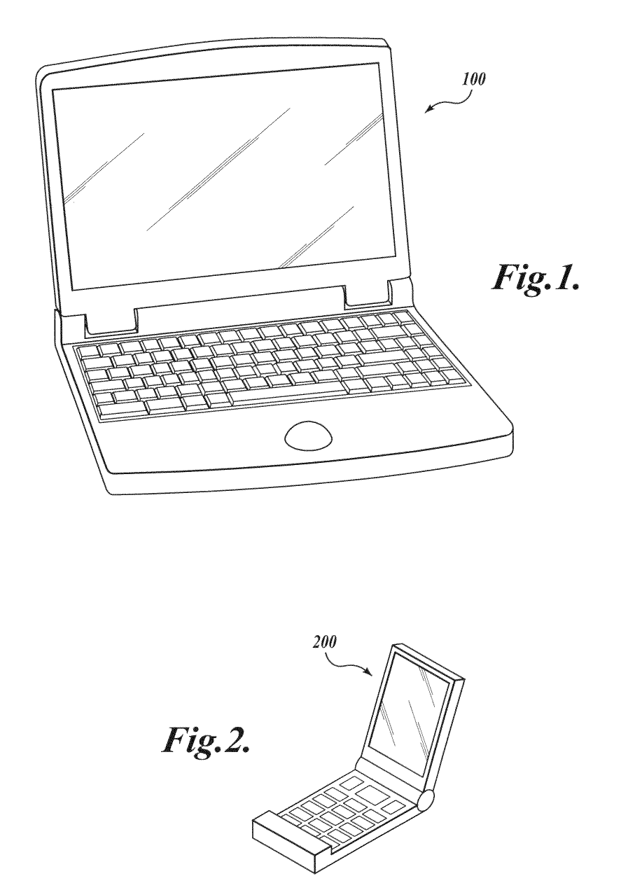

FIG. 1 illustrates a laptop, which is a small, portable personal computer that can run on batteries. A laptop 100 has a flat screen and a small keyboard. It can execute software similar to its desktop counterpart and can accept similar peripherals, such as sound cards, internal or external modems, floppy disks, and CD-ROM drives. It also has connectors for plugging in external keyboards and full-sized screen monitors. Because of the small keyboard of the laptop 100, the laptop 100 may pose a challenge for user interaction, especially in less than ideal conditions, such as low light. Furthermore, usually, the keys on the small keyboard of the laptop 100 are not arranged corresponding to the keys on the regular size keyboard coupled to larger computers. Interactions between a human and a computer are typically facilitated by an input device, which is a peripheral device whose purpose is to allow the user to provide input to the laptop 100. Various embodiments of the present invention focus on enhancing on the input device, such as a keyboard of the laptop 100. Various embodiments of the present invention allow keys on the keyboard of the laptop 100 to be made more visible, tactile, or both, using colors, shapes, or embellishments to facilitate better human interaction with the laptop 100.

FIG. 2 illustrates a wireless phone 200 which is a telephone that operates by means of radio waves without any wire connection. Instead of the wireless phone 200, other mobile, wireless devices can be suitable used, such as a personal digital assistant or a mobile, wireless device that is a text-based communication device. A base station (cellular tower) relays the telephone's signal to a wireless carrier's network, where the signal is transmitted to another wireless phone or to a wired telephone network. Similar to the laptop 100, the wireless phone 200 is becoming a computing device of choice for many mobile users. Even smaller in size than the laptop 100, the wireless phone 200 also includes a tiny keyboard allowing users to provide input to the wireless phone 200. Various embodiments of the present invention enhance a user's interaction with the wireless phone 200 by increasing visibility, tactility, or both, via colors, shapes, or physical embellishments to facilitate better interactions with the wireless phone 200.

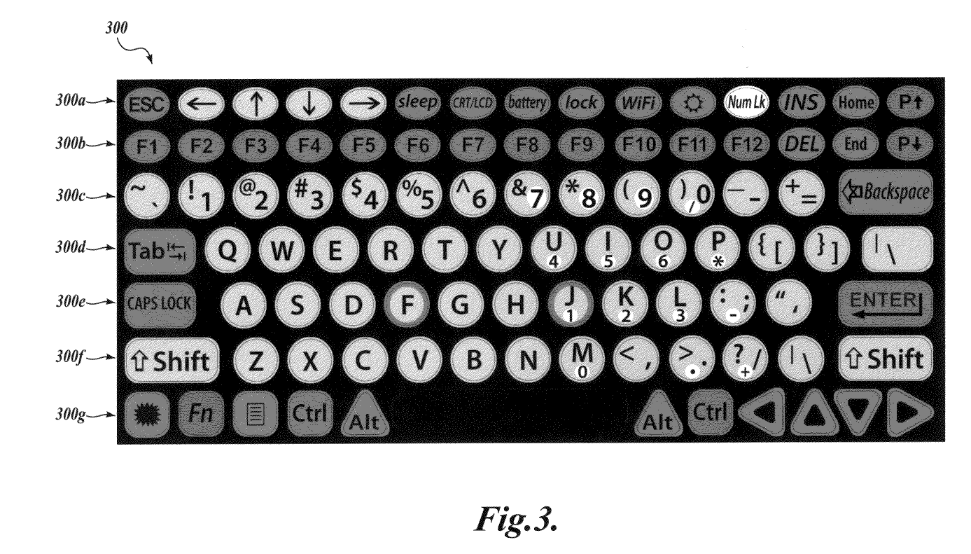

FIG. 3 illustrates an article of manufacture 300 that comprises key members that can be removed from the article of manufacture 300 to expose an adhesive bottom that can be fastened to a surface, such as on top of a keycap of a keyboard. Each keycap is a plastic piece identifying a key on a keyboard. The article of manufacture 300 includes multiple linear rows 300a-300g and several nonlinear columns. At the intersection of these linear rows 300a-300g and nonlinear columns are various key members. The key members of the article of manufacture 300 are grouped according to colors, shapes, or both. Several key members can be embellished by a structure, such as an embossment of a symbol, number, or letter, to facilitate tactile interaction by a user. In various embodiments, certain key members of the article of manufacture 300 may include luminescent ink to brighten a symbol, number, letter, or a combination, to allow visibility in low light conditions.

Any suitable color or shape can be used to improve visibility of the key members of the article of manufacture 300. Some suitable colors include hot pink, yellow, blue, and green, but others may be used. Some suitable shapes include oval, circle, rectangle, square, and triangle, but others may be used. Each of these key members can be removed from the article of manufacture 300 to reveal an adhesive bottom and be placed on a key of a keyboard so as to aid a user to better visually locate the key. Some keys may have embellishments to allow the user's fingers to have better tactile interactions with the keyboard.

Row 300a of the article of manufacture 300 includes a hot pink, oval key member, “ESC,” which can be detached from the article of manufacture 300 and attached on a key on a keyboard that sends the Escape character when actuated, causing a user interface to move back one level in a menu structure or exit a program. Four yellow, oval Arrow key members, which can be detached from the article of manufacture 300 and attached on a surface of any of four keys labeled with arrows pointing up, down, left, and right, are used to move the cursor vertically or horizontally.

A family of blue, oval key members includes (all of which can be removed from the article of manufacture 300 and attached to keys on the keyboard) a “sleep” key member for shutting down all unnecessary computer operations to save energy; a “CRT/LCD” key member for switching output signals between an external screen monitor and an integrated LCD screen; a “battery” key member that indicates current capacity of the batteries used by the computer; a “lock” key member that allows a software security feature to be activated which would require a password to be entered to allow access to the computer; a “WiFi” key member that represents access to a wireless LAN network; and a key member with a symbol of the sun that facilitates controlling brightness adjustment. Instead of combinations of words, this family of blue, oval key members may include symbols. A white, oval “Num Lk” key member, which can be detached from the article of manufacture 300 and attached to a key on a keyboard, toggles usability of a numeric keypad so that certain keys can be used for calculator-style data entry.

A hot pink, oval family of key members includes an “INS” key member whose usual function is to toggle a program's editing setting between an insert mode and an overwrite mode, and a “DEL” key member which is positioned below in row 300b and which represents a key whose function erases a character under the cursor or selected text or graphics. A blue, oval family of key members includes a “Home” key member whose function usually involves sending the cursor to some type of home position in a software application and an “End” key member located below in row 300b and operates as a cursor-control key that moves the cursor to a certain position, usually to the end of a line, end of a screen, or end of a file, depending on the program. A green, oval family of key members includes a “P↑” key member that acts as a page up key to move the cursor up to the top of the previous page or a specific number of lines and a “P↓” key member that acts as a page down key to move the cursor down to the top of the next page or a specific number of lines. Row 300b includes a green, oval family of “F1-F12” key members, which can be detached and attached to keys on the keyboard that are used for special tasks by different programs. These keys are known as function keys and can store shortcuts for common instructions or software features that are not typically available.

As will be discussed below, certain family members of yellow, circular key members comprise a subfamily that has a white circle enveloping either a mathematical symbol or a number which is produced when the “Num Lk” key is toggled. Rows 300c-300f comprise a family of key members which, when actuated, produce symbols, numbers, or letters. This family includes a “˜” key member, which can be removed and attached to a key on the keyboard associated with producing the tilde symbol or the grave accent diacritical mark (depending on the toggle position of the rectangular, yellow “Shift” key). A “! 1” key member can be detached and attached to a key on a keyboard to produce either an exclamation point or the number one (depending on the toggle position of the rectangular, yellow “Shift” key). A “@ 2” key member can be removed and attached to a key on a keyboard which produces either the “at” symbol or the number two when actuated (depending on the toggle position of the rectangular, yellow “Shift” key). A “# 3” key member can be removed and attached to a key on a keyboard to produce either the pound sign symbol or the number three when actuated (depending on the toggle position of the rectangular, yellow “Shift” key). A “$ 4” key member can be detached and attached to a key on a keyboard to produce either the dollar sign symbol or the number four when actuated (depending on the toggle position of the rectangular, yellow “Shift” key). A “% 5” key member can be detached and attached to a key on a keyboard to produce either a percentage symbol or the numerical number five when actuated (depending on the toggle position of the rectangular, yellow “Shift” key). A “̂ 6” key member can be removed from the article of manufacture 300 and attached to a key on a keyboard to produce either the caret symbol or the number six when actuated (depending on the toggle position of the rectangular, yellow “Shift” key). A “& 7” key member can be removed from the article of manufacture 300 and attached to a key on a keyboard to produce either the ampersand symbol or the number seven (depending on the toggle position of the rectangular, yellow “Shift” key and/or the oval, white “Num Lk” key). A “* 8” key member can be detached from the article of manufacture 300 and attached to a key on a keyboard to produce either the asterisk symbol or the number eight when actuated (depending on the toggle position of the rectangular, yellow “Shift” key and/or the oval, white “Num Lk” key). A “( 9” key member can be detached from the article of manufacture 300 and attached to a key on a keyboard to produce either an open parentheses symbol or the number nine when actuated (depending on the toggle position of the rectangular, yellow “Shift” key and/or the oval, white “Num Lk” key). A “) / 0” key member can be detached from the article of manufacture 300 and attached to a key on a keyboard to produce a closed parentheses symbol, a slash, or the numeral zero when actuated (depending on the toggle position of the rectangular, yellow “Shift” key and/or the oval, white “Num Lk” key). A “_ -” key member which can be detached from the article of manufacture 300 and attached to a key on a keyboard to produce either an underline symbol or a hyphen symbol when actuated (depending on the toggle position of the rectangular, yellow “Shift” key). A “+ =” key member which can be detached from the article of manufacture 300 and attached to a key on a keyboard to produce the plus symbol or the equal sign symbol when actuated (depending on the toggle position of the rectangular, yellow “Shift” key).

A “Q” key member can be detached from the article of manufacture 300 and attached to a key on a keyboard to produce the letter q or the letter Q when actuated (depending on the toggle position of the rectangular, yellow “Shift” key). A “W” key member can be detached from the article of manufacture 300 and attached to a key on a keyboard to produce the letter w or the letter W when actuated (depending on the toggle position of the rectangular, yellow “Shift” key). An “E” key member can be detached from the article of manufacture 300 and attached to a key on a keyboard to produce the letter e or the letter E when actuated (depending on the toggle position of the rectangular, yellow “Shift” key). An “R” key member can be detached from the article of manufacture 300 and attached to a key on a keyboard to produce the letter r or the letter R when actuated (depending on the toggle position of the rectangular, yellow “Shift” key). A “T” key member can be detached from the article of manufacture 300 and attached to a key on a keyboard to produce the letter t or the letter T when actuated (depending on the toggle position of the rectangular, yellow “Shift” key). A “Y” key member can be detached from the article of manufacture 300 and attached to a key on a keyboard to produce the letter y or the letter Y when actuated (depending on the toggle position of the rectangular, yellow “Shift” key). A “U 4” key member can be detached from the article of manufacture 300 and attached to a key on a keyboard to produce either the letter u, the letter U, or the numerical number 4 when actuated (depending on the toggle position of the rectangular, yellow “Shift” key and/or the oval, white “Num Lk” key). An “I 5” key member can be detached from the article of manufacture 300 and attached to a key on a keyboard to produce either the letter i, the letter I, or the numerical number 5 when actuated (depending on the toggle position of the rectangular, yellow “Shift” key and/or the oval, white “Num Lk” key). An “O 6” key member can be detached from the article of manufacture 300 and attached to a key on a keyboard to produce either the letter o, the letter O, or the numerical number 6 (depending on the toggle position of the rectangular, yellow “Shift” key and/or the oval, white “Num Lk” key) when actuated. A “P *” key member can be detached from the article of manufacture 300 and attached to a key on a keyboard to produce either the letter p, the letter P, or the asterisk symbol (depending on the toggle position of the rectangular, yellow “Shift” key and/or the oval, white “Num Lk” key) when actuated. A “{ [” key member can be detached from the article of manufacture 300 and attached to a key on a keyboard to produce either the open curly bracket symbol or the open square bracket symbol when actuated (depending on the toggle position of the rectangular, yellow “Shift” key). A “} ]” key member can be detached from the article of manufacture 300 and attached to a key on a keyboard to produce either the close curly bracket or the close square bracket symbol (depending on the toggle position of the rectangular, yellow “Shift” key) when actuated.

An “A” key member can be detached from the article of manufacture 300 and attached to a key on a keyboard to produce the letter a or the letter A (depending on the toggle position of the rectangular, yellow “Shift” key) when actuated. An “S” key member can be removed from the article of manufacture 300 and be adhered to a key on a keyboard to produce the letter s or the letter S (depending on the toggle position of the rectangular, yellow “Shift” key) when actuated. A “D” key member can be detached from the article of manufacture 300 and attached to a key on a keyboard to produce the letter d or the letter D (depending on the toggle position of the rectangular, yellow “Shift” key) when actuated. An “F” key member can be removed from the article of manufacture 300 and adhered to a key on a keyboard to produce the letter f or the letter F (depending on the toggle position of the rectangular, yellow “Shift” key) when actuated. A green annular ring appears to surround the “F” key member and facilitates the tactile feel of a user's left index finger to guide such a finger to the proper keyboard position. A “G” key member can be removed from the article of manufacture 300 and attached to a key on a keyboard to produce the letter g or the letter G (depending on the toggle position of the rectangular, yellow “Shift” key) when actuated. An “H” key member can be detached from the article of manufacture 300 and attached to a key on a keyboard to produce the letter h or the letter H when actuated. A “J 1” key member can be detached from the article of manufacture 300 and attached to a key on a keyboard to produce either the letter j or the letter J or the numeral 1 (depending on the toggle position of the rectangular, yellow “Shift” key and/or the oval, white “Num Lk” key) when actuated. A green annular ring encompassing the “J 1” key member tactilely and visually aids the user to place his right index finger in the proper keyboard position. A “K 2” key member can be detached from the article of manufacture 300 and attached to a key on a keyboard to produce either the letter k or the letter K or the numerical number 2 (depending on the toggle position of the rectangular, yellow “Shift” key and/or the oval, white “Num Lk” key) when actuated. An “L 3” key member can be detached from the article of manufacture 300 and attached to a key on a keyboard to produce either the letter 1 or the letter L or the numeral 3 (depending on the toggle position of the rectangular, yellow “Shift” key and/or the oval, white “Num Lk” key) when actuated. A “: ; -” key member can be removed from the article of manufacture 300 and attached to a key on a keyboard to produce a colon symbol, a semicolon symbol, or a minus symbol (depending on the toggle position of the Num Lk key as well as the toggle position of the Shift key) when actuated. A ““ ”” key member can be detached from the article of manufacture 300 and attached to a key on a keyboard to produce either the double quote symbol or the single quote symbol (depending on the toggle position of the Shift key) when actuated.

A “Z” key member can be detached from the article of manufacture 300 and attached to a key on a keyboard to produce the letter z or the letter Z (depending on the toggle position of the rectangular, yellow “Shift” key) when actuated. An “X” key member can be removed from the article of manufacture 300 and attached to a key on a keyboard to produce the letter x or the letter X (depending on the toggle position of the rectangular, yellow “Shift” key) when actuated. A “C” key member can be detached from the article of manufacture 300 and attached to a key on a keyboard to produce the letter c or the letter C (depending on the toggle position of the rectangular, yellow “Shift” key) when actuated. A “V” key member can be removed from the article of manufacture 300 and attached to a key on a keyboard to produce the letter v or the letter V (depending on the toggle position of the rectangular, yellow “Shift” key) when actuated. A “B” key member can be removed from the article of manufacture 300 and attached to a key on a keyboard to produce the letter b or the letter B (depending on the toggle position of the rectangular, yellow “Shift” key) when actuated. An “N” key member can be detached from the article of manufacture 300 and attached to a key on a keyboard to produce the letter n or the letter N (depending on the toggle position of the rectangular, yellow “Shift” key) when actuated. An “M 0” key member can be removed from the article of manufacture 300 and adhered to a key on a keyboard to produce either the letter m, the letter M, or the number 0 (depending on the toggle position of the rectangular, yellow “Shift” key and/or the oval, white “Num Lk” key) when actuated. A “<,” key member can be removed from the article of manufacture 300 and attached to a key on a keyboard to produce either the open angle bracket symbol or the comma symbol (depending on the toggle position of the Shift key) when actuated. A “>°.” key member can be removed from the article of manufacture 300 and attached to a key on a keyboard to produce either the close angle bracket symbol or the period symbol or a decimal symbol (depending on the toggle position of the Num Lk key as well as the toggle position of the Shift key) when actuated. A “? / +” key member can be detached from the article of manufacture 300 and attached to a key on a keyboard to produce the question mark symbol, a slash, or the plus symbol (depending on the toggle position of the Num Lk key as well as the toggle position of the Shift key) when actuated. A “| \” key member can be detached from the article of manufacture 300 and attached to a key on a keyboard to produce either the vertical bar symbol or the backslash (depending on the toggle position of the Shift key) when actuated. Several members of the yellow, circular key members produce different numbers and symbols depending on the toggle position of the Num Lk key, such as the “& 7”, “* 8”, “( 9”, “) 0 /”, “U 4”, “I 5”, “O 6”, “P *”, “J 1”, “K 2”, “L 3”, “: ; -”, “M 0”, “> .”, and “? / +” key members.

Row 300c includes a hot pink, rectangular “Backspace” key member which can be removed from the article of manufacture 300 and attached to a key on a keyboard to cause the cursor to move to the left, one character at a time, usually erasing each character as it moves. Column 300d includes a hot pink, rectangular “Tab” key member which can be removed from the article of manufacture 300 and attached to a key on a keyboard to insert tab characters into a document, and in menu-driven programs, the key can be used to move the on-screen highlight from place to place. A yellow, rectangular “| \” key member can be removed from the article of manufacture 300 and attached to a key on a keyboard to produce a vertical bar or a backslash when actuated (depending on the toggle position of the rectangular, yellow “Shift” key). Row 300e includes a green, rectangular “Caps Lock” key member which can be removed from the article of manufacture 300 and attached to a key on a keyboard to produce uppercase alphabetic characters when toggled. Note that the green, rectangular “Caps Lock” key member has a similar color green that encompasses the “F” key member and the “J 1” key member to help visually aid the user to bring his index fingers into suitable typing position. Row 300e also includes a green, rectangular “Enter” key member which can be removed from the article of manufacture 300 and attached to a key on a keyboard to instruct a piece of software to execute a command or text, and in the case of word processing programs, used at the end of a paragraph. Row 300f includes yellow, rectangular “Shift” key members which can be removed from the article of manufacture 300 and attached to a key on a keyboard which, when pressed in combination with another key, provides an alternative meaning to that key, such as producing an uppercase character when a letter key is actuated. Row 300g includes a hot pink, square key member with a splatter symbol that can be removed from the article of manufacture 300 and attached to a key on Apple™ keyboards labeled with an outline of the Apple™ logo which functions similarly to the Control key on PC keyboards and is typically used with a character key as a shortcut to menu selections or starting a macro, or the key member can be used to attach to a key on PC keyboards labeled with a representation of the Microsoft Windows logo to cause the Start Menu to appear. A blue, square “Fn” key member, residing in row 300g, can be removed from the article of manufacture 300 and attached to a key on a keyboard that when actuated in combination with other key members, such as “Sleep”, “CRT/LCD”, “Battery”, “Lock”, “WiFi”, or the Brightness key, allows the latter keys to be activated. A hot pink, square key member with a symbol of an abstracted menu can be removed from the article of manufacture 300 and attached to a key on a keyboard to cause a right-click menu to appear on the screen. Two green, square “Ctrl” key members can be detached from the article of manufacture 300 and attached to a key on a keyboard that, when pressed in combination with another key, gives the other key an alternate meaning or function. Two hot pink, triangular “Alt” key members can be removed from the article of manufacture 300 and attached to a key on a keyboard that can be used in conjunction with another key to produce some special feature or function that is typically connected with the Alt key. Alternative arrow key members in hot pink, rectangular shape are provided.

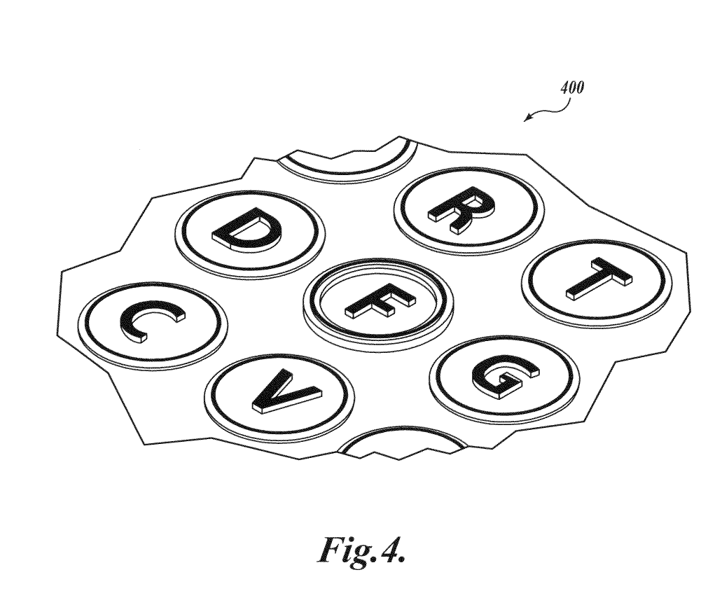

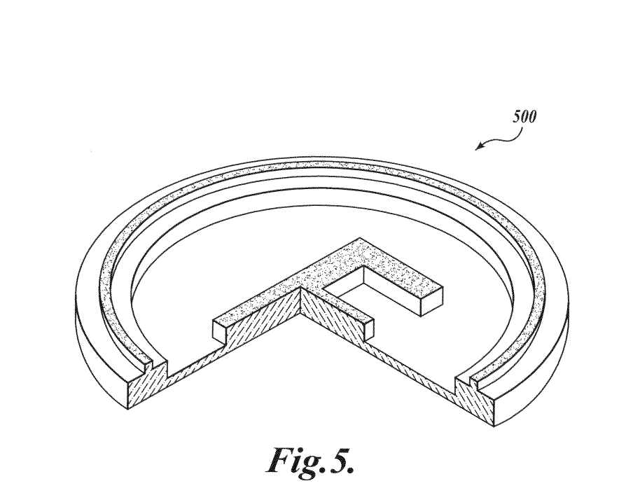

FIG. 4 illustrates a portion 400 of the article of manufacture 300 in more detail. Specifically, “R”, “T”, “G”, “V”, “C”, “D”, and “F” key members are featured. Each of these key members are shown with a certain thickness, which helps to ease removal from the article of manufacture 300 to reveal an adhesive layer. This adhesive layer is used to couple the key members to keys on a keyboard. Each key member is bordered by a threshold line indicating a distance within which a cutting process will be executed to separate the key members from the article of manufacture, allowing ease of removal from the article of manufacture.

FIG. 5 illustrates a portion 500 of the portion 400 in more detail. Particularly, the letter F is manufactured as a relief, whose shape is projected from a bottom surface of the key member. Ink is applied to the top surface of the letter F. Other key members may be set in a relief similarly to the letter F. Also projecting from the bottom surface of the key member is an annular wall, and projecting from the annular wall is a circular lip in relief, which surrounds the wall and the letter F in relief.

Many suitable manufacturing processes are possible to produce the key members of the article of manufacture 300. In one suitable manufacturing process, a sheet of adhesive is set. A layer of substrate using a suitable material, such as vinyl, is positioned on top of the sheet of adhesive. Another layer of substrate suitably formed from vinyl is positioned on top of the first layer of substrate. Using a lithography process, symbols, letters, numbers, and die tolerance are printed on the last layer. Preferably, the symbols, letters, and numbers are printed using large font sizes around 18 to 24 points. A layer of clear matte material, such as vinyl, is placed on top of the second layer of substrate to protect the rendered symbols, letters, or numbers. Optional embellishment processes, such as embossment, are executed. An article of manufacture, such as the article of manufacture 300, is produced by cutting the layers in sheets.

While illustrative embodiments have been illustrated and described, it will be appreciated that various changes can be made therein without departing from the spirit and scope of the invention.

The embodiments of the invention in which an exclusive property or privilege is claimed are defined as follows:

1. An article of manufacture for enhancing input device ergonomics, comprising:
an adhesive layer; and
a substrate layer fastened to the adhesive layer on which key member families of symbols, letters, and numbers are grouped according to colors, shapes, and types, each key member being detachable from the article of manufacture and attachable to a corresponding key on a keyboard so as to allow better user interaction with a computing device.

2. The article of manufacture of claim 1 wherein the key members correspond to keys of a keyboard of a laptop computer.

3. The article of manufacture of claim 1 wherein the key members correspond to keys of a cellular telephone.

4. The article of manufacture of claim 1 wherein key member families include key members with tactile embellishments.

5. The article of manufacture of claim 1 wherein key member families include key members whose colors are formed from luminescent ink.

6. The article of manufacture of claim 1 wherein key member families include a predetermined color, oval “Num Lk” key member that corresponds to a key on a keyboard for toggling usability of a numeric keypad, and circular key members comprising a “& 7” key member that has a spot of the predetermined color covering the “7”, a “* 8” key member that has a spot of the predetermined color covering the “8”, a “( 9” key member that has a spot of the predetermined color covering the “9”, a “) / 0” key member that has a spot of the predetermined color covering the “/”, a “U 4” key member that has a spot of the predetermined color covering the “4”, an “I 5” key member that has a spot of the predetermined color covering the “5”, an “O 6” key member that has a spot of the predetermined color covering the “6”, a “P *” key member that has a spot of the predetermined color covering the “*”, a “J 1” key member that has a spot of the predetermined color covering the “1”, a “K 2” key member that has a spot of the predetermined color covering the “2”, an “L 3” key member that has a spot of the predetermined color covering the “3”, a “: ; -” key member that has a spot of the predetermined color covering the “-”, an “M 0” key member that has a spot of the predetermined color covering the “0”, a “>°.” key member that has a spot of the predetermined color covering the “.”, and a “? / +” key member that has a spot of the predetermined color covering the “+”.

7. The article of manufacture of claim 1 wherein key member families include a circular “F” key member and a circular “J 1” key member, both key members being marked by an annular ring of a predetermined color, the key member families including a “CAPS LOCK” key member and an “ENTER” key member, both of which include the predetermined color.

8. The article of manufacture of claim 1 wherein key member families include a square key member with a cloud symbol that corresponds to either a key on Apple™ keyboards labeled with an outline of the Apple™ logo or to a key on PC keyboards labeled with a representation of the Microsoft Windows logo.

9. An input device to a computer, comprising:
a keyboard with keys; and
key members of an article of manufacture which are organized into key member families of symbols, letters, and numbers according to colors, shapes, and types, each key member being detachable from the article of manufacture and attachable to a corresponding key on the keyboard so as to allow better user interaction with the computer.

10. The input device of claim 9 wherein key member families include key members whose colors are formed from luminescent ink.

11. An input device to a cellular phone, comprising:
an integrated keyboard with keys that are coupled to the cellular phone; and
key members of an article of manufacture which are organized into key member families of symbols, letters, and numbers according to colors, shapes, and types, each key member being detachable from the article of manufacture and attachable to a corresponding key on the keyboard so as to allow better user interaction with the cellular phone.

12. The input device of claim 11 wherein key member families include key members whose colors are formed from luminescent ink.
